(19) United States
(12) Patent Application Publication
(10) Pub. No.: US 2025/0118072 A1
(43) Pub. Date: Apr. 10, 2025

(54) METHOD FOR DETECTING COMPLEX TARGET IN PEDESTRIAN RE-IDENTIFICATION VIDEO STREAMS BASED ON EVENT-RELATED POTENTIAL (ERP)

(71) Applicant: Hangzhou Dianzi University, Hangzhou City (CN)

(72) Inventors: Wanzeng KONG, Hangzhou City (CN); Chenyi HONG, Hangzhou City (CN); Jiabin ZHU, Hangzhou City (CN); Longjie MA, Hangzhou City (CN); Li ZHU, Hangzhou City (CN); Jianhai ZHANG, Hangzhou City (CN)

(21) Appl. No.: 18/908,505

(22) Filed: Oct. 7, 2024

(30) Foreign Application Priority Data
Oct. 8, 2023 (CN) 202311291753.8

(51) Int. Cl. G06V 20/40; G06F 3/01; G06N 3/0464; G06N 3/084; G06N 20/10; G06V 10/80; G06V 10/82

(52) U.S. Cl. CPC G06V 20/41; G06F 3/015; G06N 3/0464; G06N 3/084; G06N 20/10; G06V 10/811; G06V 10/82; G06V 2201/07

(57) ABSTRACT

Provides is a method for detecting a complex target in pedestrian re-identification video streams based on an event-related potential (ERP). According to the method, video streams of a complex target in different scenarios are collected, and are made into experimental paradigms, and electroencephalogram (EEG) data of a subject during watching of a video content is collected. Then brain electrical activity mapping (BEAM) is analyzed, and ERP features are marked, including P300 and P300-D, which correspond to target emergence and target disappearance respectively. Positive and negative sample pairs are constructed, and essential features between classes are obtained based on a method of contrastive representation learning and a method of spatial-temporal feature attention extraction, so as to solve the extreme class imbalance problem of samples and the problem of how to distinguish between two similar classes in a video paradigm.

### CROSS REFERENCE TO RELATED APPLICATION

This patent application claims the benefit and priority of Chinese Patent Application No. 202311291753.8, filed with the China National Intellectual Property Administration on Oct. 8, 2023, the disclosure of which is incorporated by reference herein in its entirety as part of the present application.

### TECHNICAL FIELD

The present disclosure relates to the technical field of brain-computer collaboration, and relates to a pedestrian re-identification target detection method, and in particular, to a method for detecting a complex target in pedestrian re-identification video streams based on an event-related potential (ERP).

### BACKGROUND

In recent years, with the rise and wide application of surveillance cameras, a large number of surveillance videos are produced every day in cities to assist in urban operation and municipal management. In video streams with the same image size, video frames containing more information are larger in data volume, which increases a calculation amount and time of a machine. There is a wide range of urgent needs for identification of a complex target of video streams in smart cities, military security, and other fields. Identification of a complex object is an identification task in which there are other interference factors besides the to-be-identified target in a scenario, and the target appears is an uncertain form and has camouflage. Feature expression of the complex object is sparse, uncertain or even lacking. Therefore, how to process and effectively extract complex information hidden in these massive videos is a key topic to be studied.

The human brain has the ability of automatic association, deduction and internal abstraction, and can quickly and accurately identify a target. Compared with a video frame image, an electroencephalogram (EEG) signal has a relatively small data volume, but has a larger coupling information amount. In addition, a brain-computer interface (BCI) has been proved to be used for expansion of the motor ability of a patient with paralysis or other diseases, as well as military target identification and other different scenarios, such as finding a target image from a large number of images or identifying emotions.

The EEG signal has the advantages of high temporal resolution, low cost, portability, and the like, and is one of the most commonly used neuroimaging technologies in the BCI. P300 is an ERP occurring in a cognitive process of the brain, which is mainly related to psychological factors such as expectation, motivation, arousal and attention. Sutton et al. found that when a small probability related event stimulates the human brain, a positive peak with a latency of 300 ms appears in the EEG signal, and is named P300. In a brain-computer interface system based on P300, the most classic application is to spell characters through directional stimulation. P300, as the basic feature of ERP, is widely used in the study of EEG signals, especially in an experiment of rapid serial visual presentation (RSVP). At present, EEG target detection is mainly aimed at the RSVP of still images and a synchronization experiment of stimulation and epilepsy markers, and there are few short visual representation paradigms based on a video streams. In the video paradigm, the target may appear at any time, but there is a lack of accurate target emergence time. In addition, due to a delay of detection time jitter, data cannot be extracted and processed effectively in a later stage, which makes a conventional image target detection method unable to be directly applied to a video stream target detection task.

In addition, because P300 is an EEG ERP feature caused by a small probability event, the probability of target emergence is low during an experiment, which leads to imbalance of a ratio of positive samples and negative samples and imbalance of a number of samples during data collection. In addition, due to the characteristics of P300, the characteristics of P300 disappear when the target just appears in the video paradigm, which makes it impossible to use, in a later stage of a video of target emergence, P300 as the basis of determining whether the target appears, and other characteristics need to be found as the determining basis. It is still a very great challenge to learn potential invariants in EEG features.

### SUMMARY

In view of the shortcomings of the prior art, the present disclosure provides a method for detecting a complex target in pedestrian re-identification video streams based on an ERP, which uses another reliable ERP to assist in identifying emergence and disappearance of the complex target in the video streams, thus solving the class imbalance problem and improving target identification accuracy.

The method for detecting a complex target in pedestrian re-identification video streams based on an ERP specifically includes the following steps:

### Step 1: Collection of Experimental Materials

A plurality of video streams with a same duration are shot at different angles in a same place as experimental paradigms, and no to-be-identified complex target appears in some of the experimental paradigms. In the rest of the experimental paradigms, duration during which a to-be-identified complex target appears is the same, while other conditions are different.

### Step 2: Collection of EEG Data

RSVP paradigms in a BCI are used, and EEG data of a subject during watching of the experimental paradigms collected in step 1 is collected.

### Step 3: Data Preprocessing and EEG Analysis

The EEG data collected in step 2 is subjected to filtering and independent component analysis, and an obvious noise signal that is unrelated to a principal component is removed. Then brain electrical activity mapping (BEAM) is analyzed, and ERP features are marked, including P300 and P300-D. P300-D refers to a positive peak value lasting for 300 ms after target disappearance.

### Step 4: Sample Pairing

EEG data in the case of no target, in the case of target emergence and in the case of target disappearance is respectively intercepted from EEG data processed in step 3, to obtain three types of samples, that is, samples in the case of no target, samples in the case of target emergence and samples in the case of target disappearance. Then the samples are combined in pairs. Samples of a same class are combined in pairs to form three types of positive sample pairs, and samples of different classes are combined in pairs to form three types of negative sample pairs.

### Step 5: Feature Extraction

Samples are first input into an efficient channel attention network (ECANet), a temporal attention weight and a spatial attention weight are extracted, and the samples are calibrated. Then calibrated samples are input into a plurality of ECANets with a same structure, a calibration operation is repeated, and finally features output by the plurality of ECANets are fused to obtain feature vectors of the samples.

### Step 6: Contrastive Learning

The feature vectors of the samples obtained in step 5 are mapped into a low-latitude vector space, and a distance between feature vectors of two samples in a sample pair on the same vector space is calculated. Back propagation is performed by using circle loss, and model parameters are updated, so that a distance between two samples in a positive sample pair is smaller, while a distance between two samples in a negative sample pair is larger.

### Step 7: Detection of a Complex Target in Video Streams

EEG signals during observation of the video streams are collected, and are input into a model trained in step 6 to detect whether the complex target appears and an emergence time and a disappearance time of the complex target.

The present disclosure has the following beneficial effects:

According to the method, during detection of a complex target, a positive peak value that lasts for 300 ms after the target disappears is used as an ERP feature for assisting P300, which greatly improves accuracy of online target detection and a positive hit rate of target search. Essential features between classes are obtained by using a method of contrastive representation learning and a method of spatial-temporal feature attention extraction, so as to solve the extreme class imbalance problem of samples and the problem of how to distinguish between two similar classes in a video paradigm. Back propagation is performed by using Circle Loss, and learning efficiency of a classifier is increased.

### BRIEF DESCRIPTION OF THE DRAWINGS

FIG. 1 is a flowchart of a method for detecting a complex target in pedestrian re-identification video streams;

FIG. 2 is a flowchart showing EEG data collection in an embodiment;

FIGS. 3A-3B are screenshot of an experimental paradigm used in an embodiment;

FIGS. 4A-4T are EEG superposition average diagrams of different samples in an embodiment; and

FIG. 5 is a schematic structural diagram of a model for feature extraction in an embodiment.

### DETAILED DESCRIPTION OF THE EMBODIMENTS

The present disclosure will be further illustrated below with reference to the accompanying drawings.

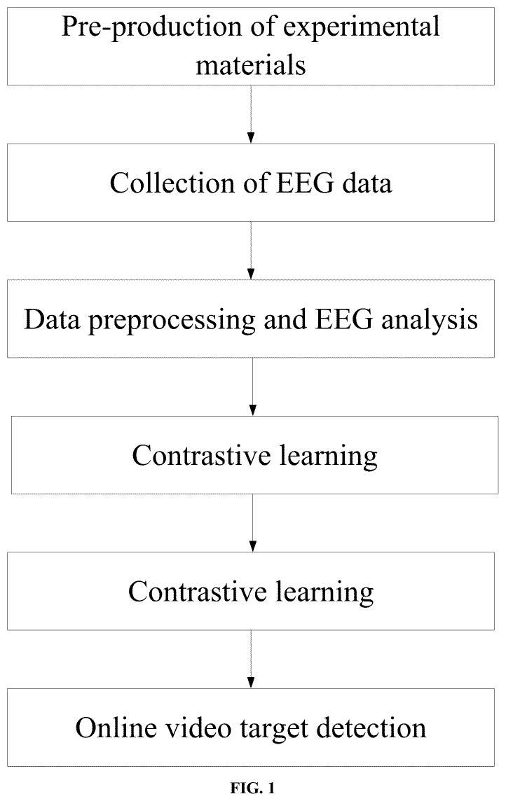

As shown in FIG. 1, a method for detecting a complex target in pedestrian re-identification video streams based on an ERP specifically includes the following steps.

### Step 1: Collection of Experimental Materials

A visual angle of a surveillance camera is simulated in a same place as much as possible, and a plurality of video streams are shot from different angles. No to-be-identified complex target appears in some video streams. In the rest of the video streams, duration during which the to-be-identified complex target appears is the same, and is 4 s, while positions, emergence time points and disappearance times of the complex target are different, and clothes worn by the complex target and vehicles used change randomly. In order to further improve camouflage of the complex target in a video, there are other articles or pedestrians unrelated to the complex target in a shot scenario. The collected video streams are edited, so that the duration is 10 s, and the target appears at the 1^{st} s, 2^{nd} s, 3^{rd} s, 4^{th} s or 5^{th} s of the video, and correspondingly disappears at the 5^{th} s, 6^{th} s, 7^{th} s, 8^{th} s or 9^{th} s of the video.

### Step 2: Collection of EEG Data

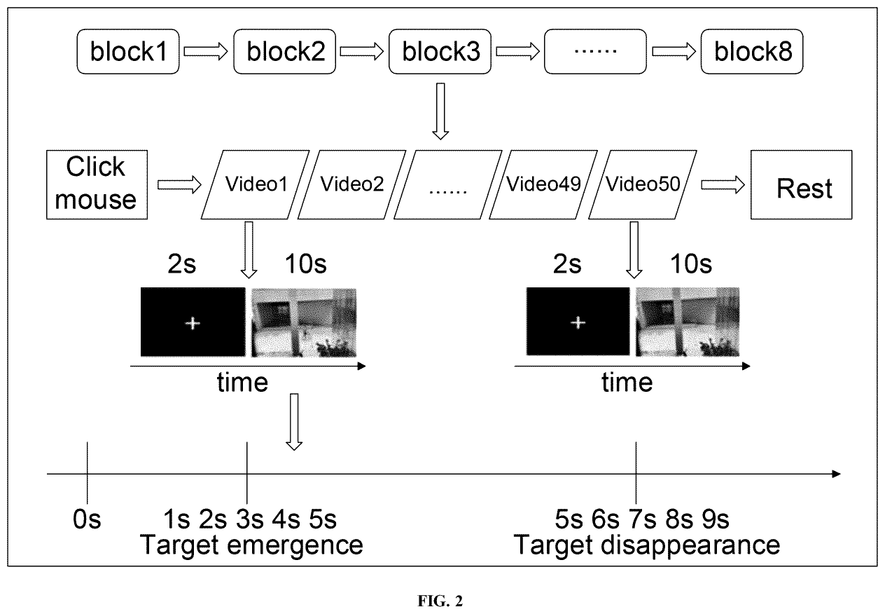

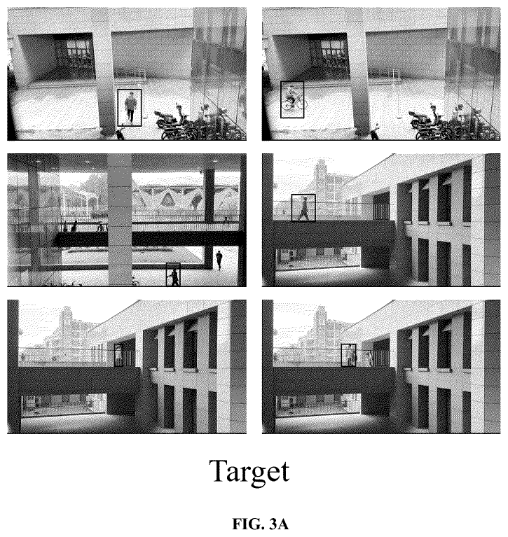

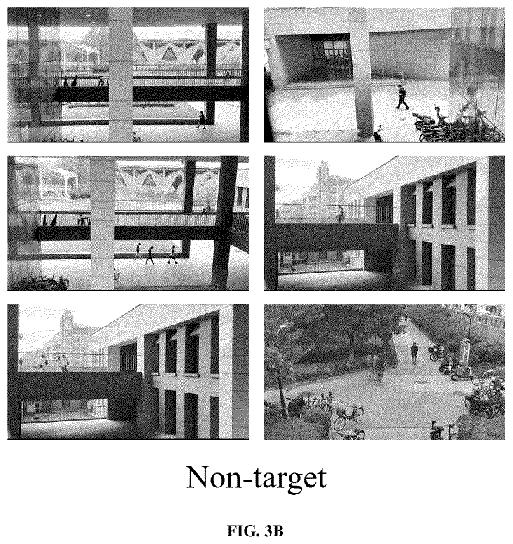

As shown in FIG. 2, RSVP paradigms in a BCI are used, and a stimulating video is an edited video from step 1. The complex target occasionally appears in a direction of an image of each video. As shown in FIGS. 3A-3B, a complex target is a specific person. There are six classes of stimulating videos, that is, no target appears, the target appears at the 1^{st} s, the target appears at the 2^{nd} s, the target appears at the 3^{rd} s, the target appears at the 4^{th} s, and the target appears at the 5^{th} s. A total of 200 videos are played. A ratio of a number of videos in which the target appears and a number of videos in which no target appears is 1:1.

During EEG data collection, a subject is about 70 cm away from a screen where stimulating videos are played. A 64-channel Neuroscan device is used for non-invasive collection. A method for placing 10-20 system electrodes is adopted. Before collection, impedance of all electrodes is kept at 15Ω or below, and a sampling rate is 1,000 Hz. The subject needs to complete 8 batches of watching tasks, and each batch contains 25 videos. After each video is played, a “+” symbol appears in the center of the screen for 2 s, so that the subject can have a rest and concentrate. After each batch is finished, the subject clicks a mouse to start watching the next batch of videos, or choose to have a rest. During watching of a video, the subject should always pay attention to whether the complex target appears, and keep staring at the complex target after the complex target appears.

### Step 3: Data Preprocessing and BEAM Analysis

Butterworth bandpass filtering is performed on the EEG data collected in step 2, with a passband range of 0.1-40 Hz, and then down-sampling is performed to 250 Hz. Finally, continuous EEG data is divided into a plurality of segments, and 100 ms EEG data after the start of stimulation is used to perform baseline calibration on 0-1,500 ms EEG data after the start of stimulation. After calibration, slices are extracted at certain time intervals from EEG data where no target appears as samples in the case of no target. EEG data from 300 ms before target emergence to 1,200 ms after the target emergence is intercepted as EEG data with target emergence as the samples in the case of target emergence; and EEG data from 300 ms before target disappearance to 1,200 ms after target disappearance is intercepted as the samples in the case of target disappearance.

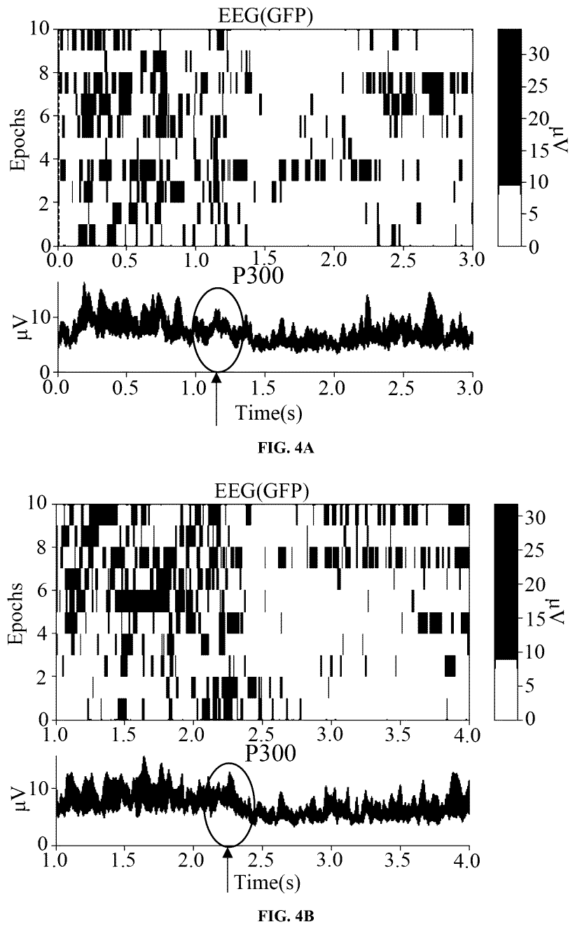

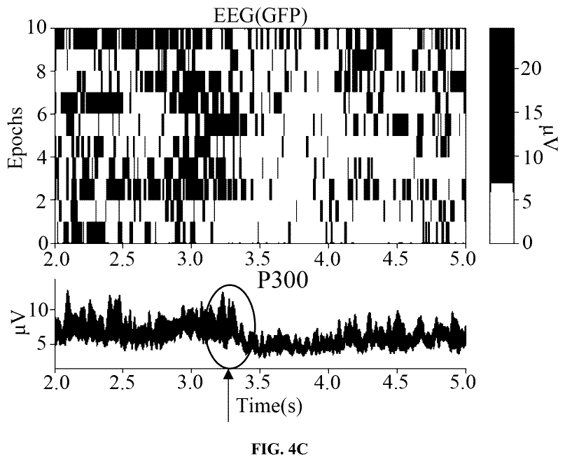

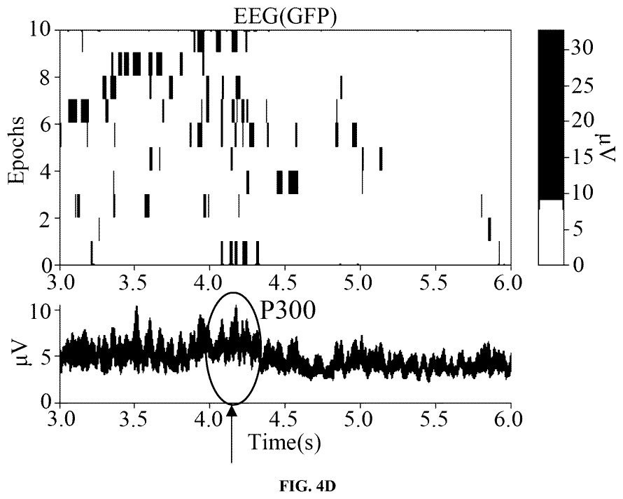

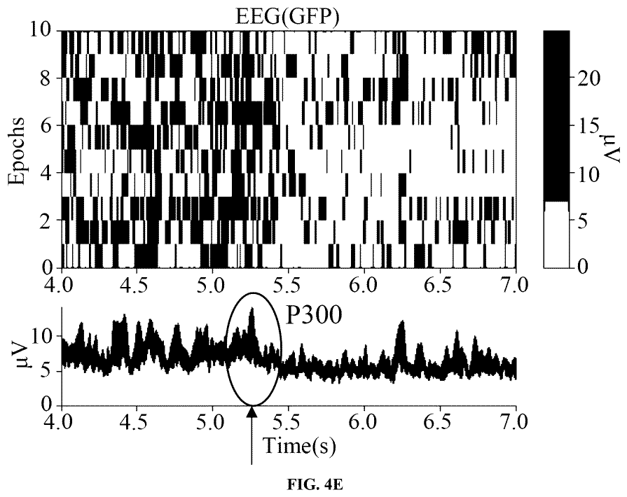

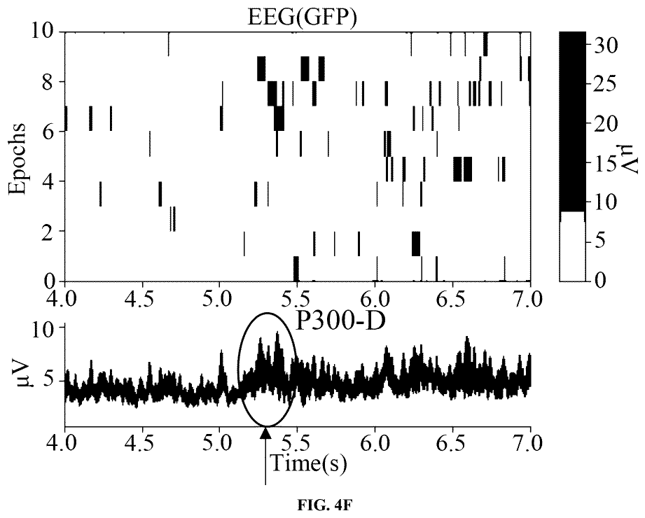

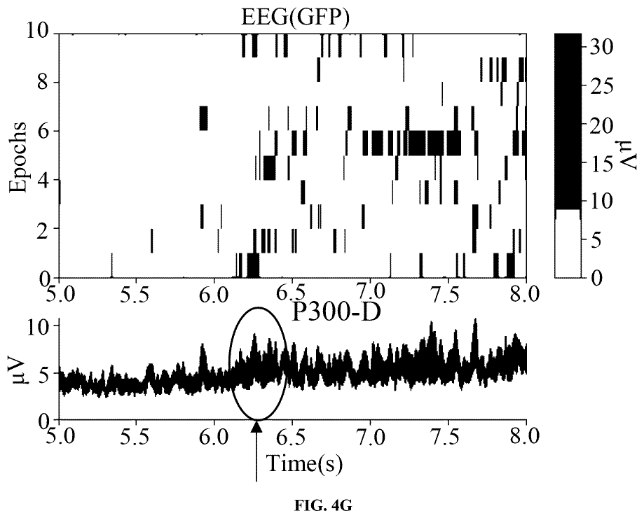

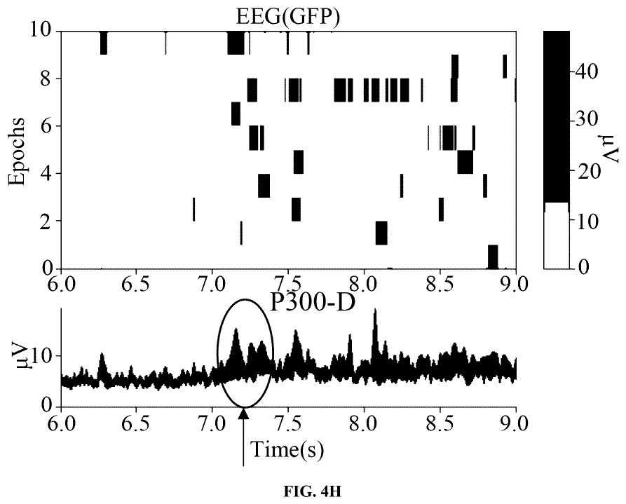

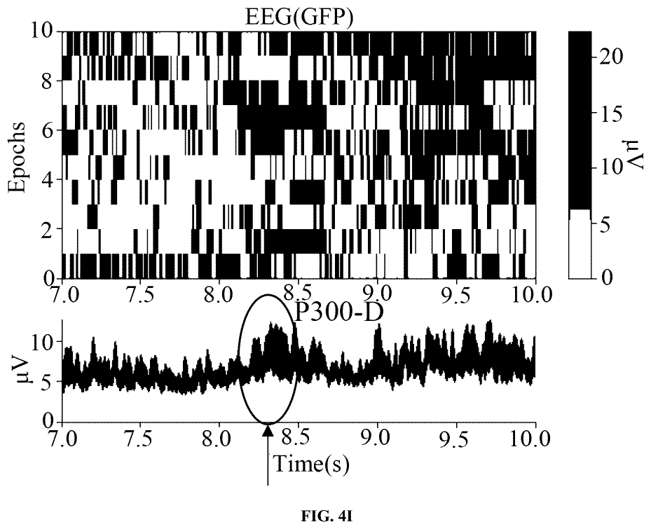

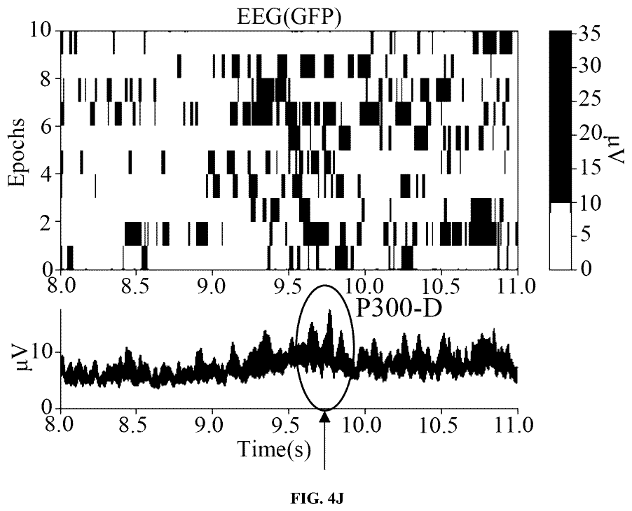

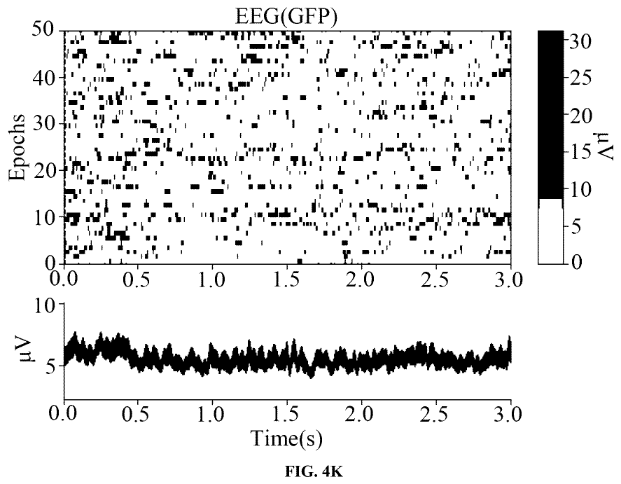

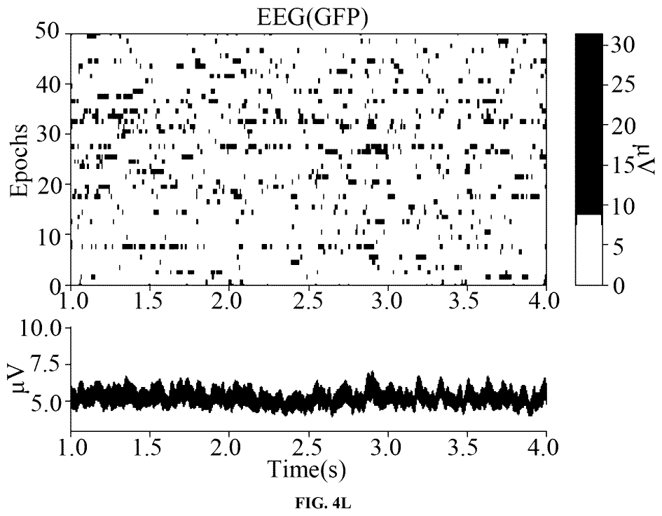

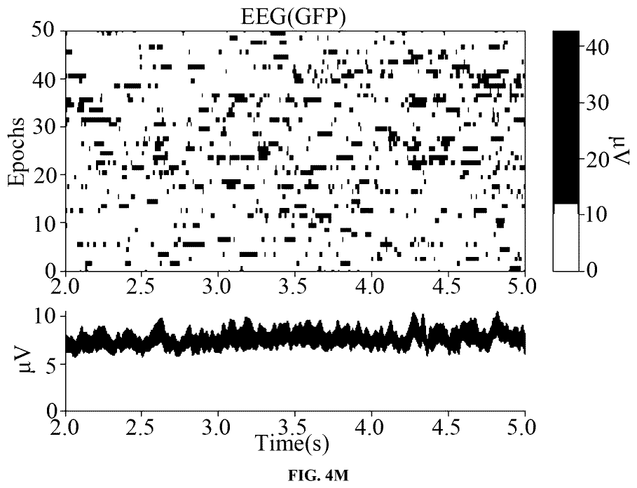

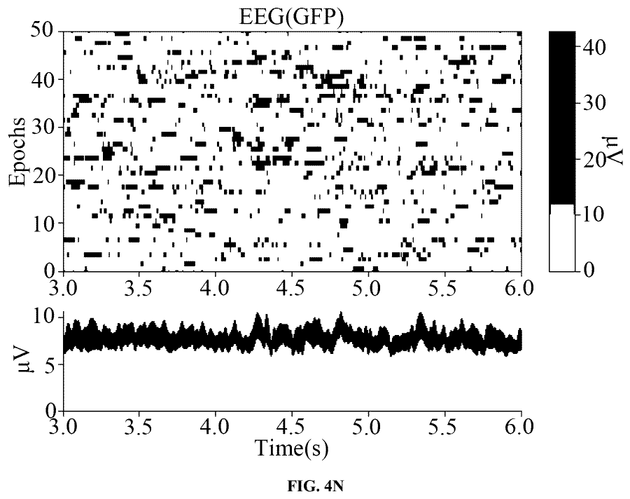

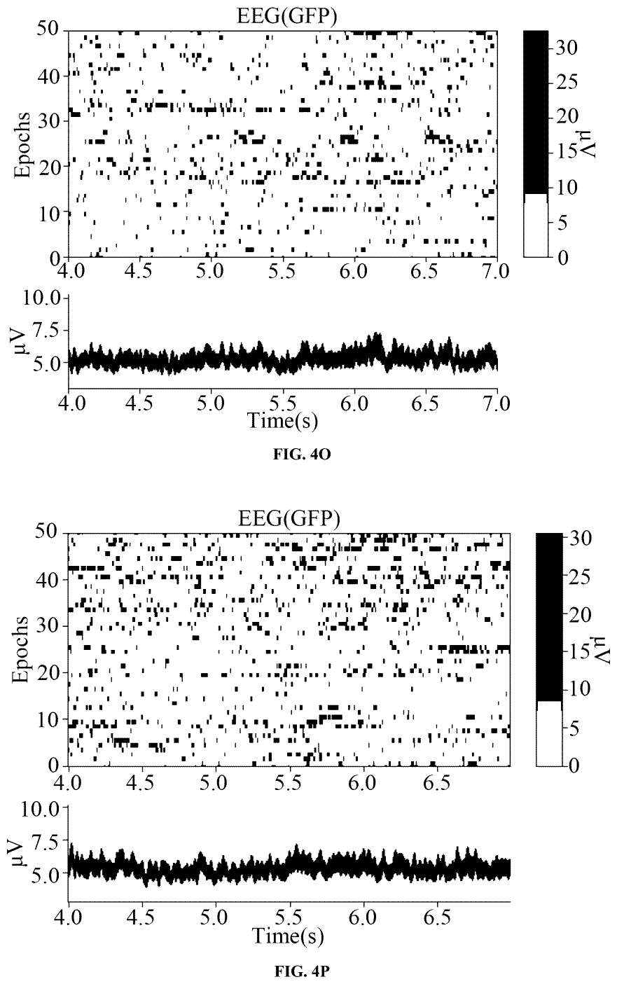

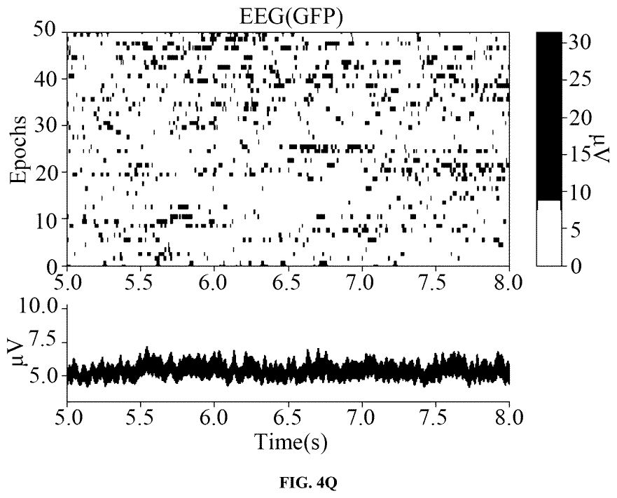

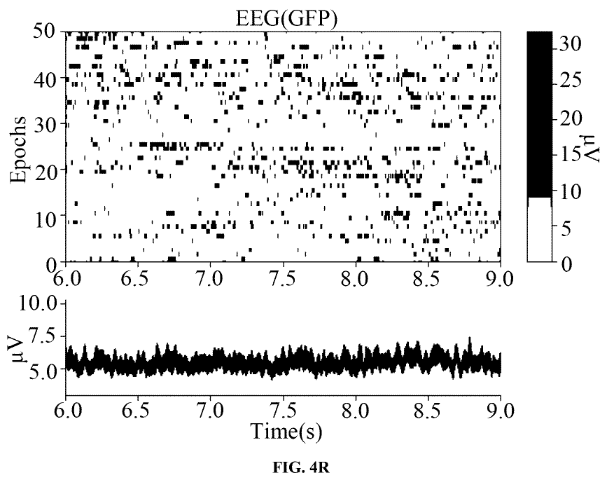

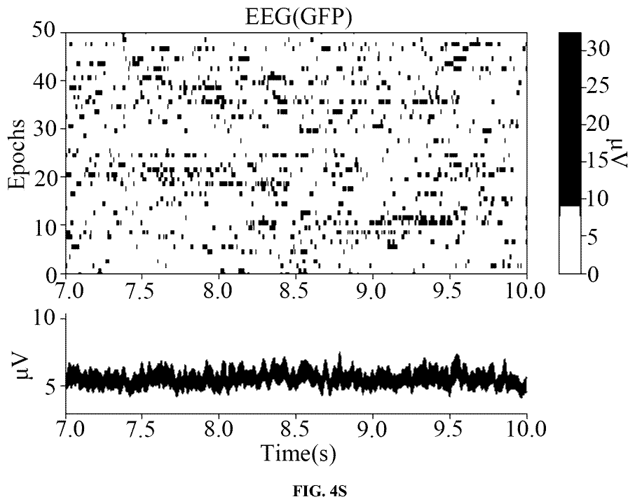

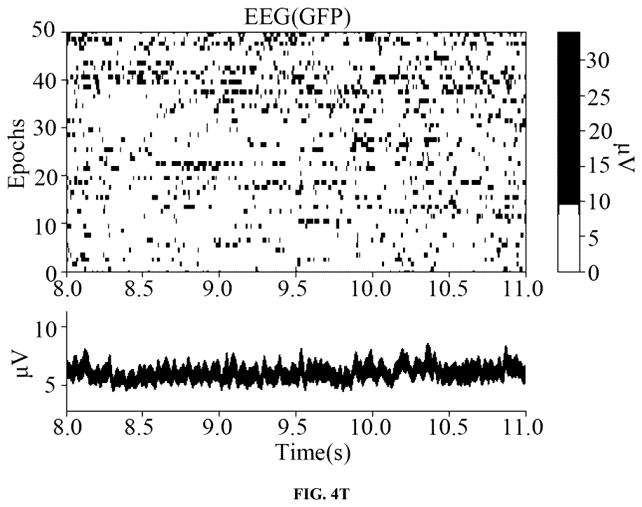

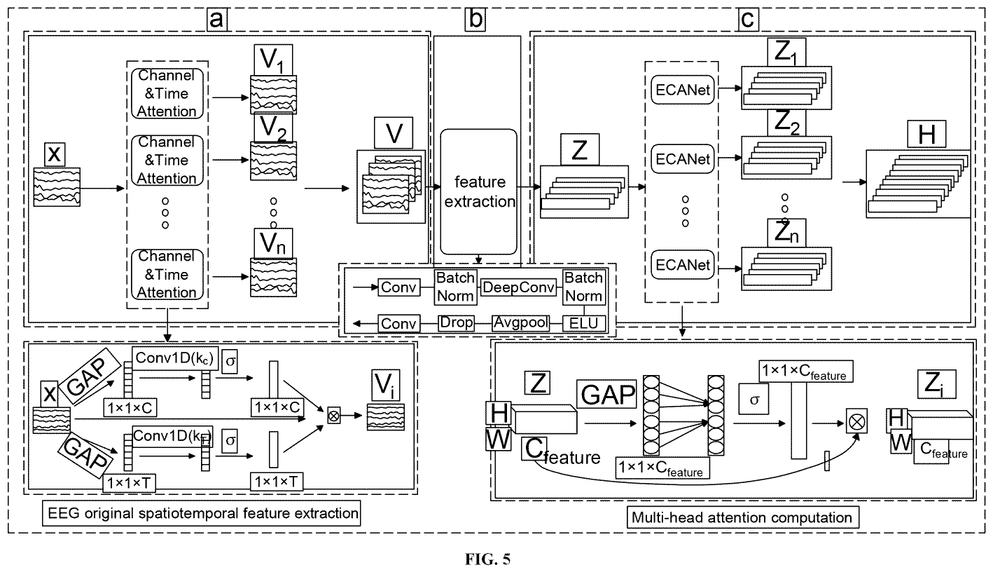

EEG analysis is performed on the samples. FIGS. 4A-4T are EEG superposition average diagrams of different samples. It can be clearly observed that a forward wave similar to P300 was generated at about 300 ms after the target disappeared, and is named P300-D.

### Step 4: Sample Pairing

With regard to the three classes of samples intercepted in step 3, the samples are combined in pairs. Samples of a same class are combined in pairs to form three types of positive sample pairs, and samples of different classes are combined in pairs to form three types of negative sample pairs.

$$\frac{N U M}{2}$$

positive sample pairs and

$$\frac{N U M}{2}$$

negative sample pairs are constructed.

### Step 5: Feature Extraction

As shown in FIG. 5, samples in the positive and negative sample pairs are input into the model, and corresponding feature vectors are extracted. A specific method includes the following steps.

S5.1: Use an ECANet to extract a temporal attention weight and a spatial attention weight of a sample Qᵢ= [symbol] ^{C×T}, weight the sample, explicitly model interdependencies between different channels to adaptively recalibrate electrode channel response characteristics, and explore discriminant features in a spatial domain to obtain a calibrated sample \tilde{Q}ᵢ, where T represents a sample length, C represents a number of channels, i=1, 2, . . . , N, and N represents a total number of samples.

Taking extraction of the spatial attention weight as an example:

An input sample \tilde{Q}ᵢ is first subjected to a global average pooling operation, and feature maps are aggregated in spatial dimension to generate channel descriptors, so as to generate global distribution embedding of channel feature responses. All layers are allowed to use information from a global receiving domain of the network:

$${z}_{i c} = {F}_{s q} ( {Q}_{i c} ) = \frac{1}{T} {Σ}_{j = 1}^{T} {q}_{i c} ( j )$$

where F_{sq}( ) represents the global average pooling operation, z_{ic} represents a descriptor of a c^{th} channel in an i^{th} sample, z_{ic}ϵ [symbol] ^{C}, Q_{ic} represents a signal Q_{ic}ϵ [symbol] ^{T} of the c^{th} channel in the i^{th} sample, and q_{ic}(j) represents a j^{th} time point of the c^{th} channel in the i^{th} sample.

Then the channel descriptor z_{ic} is input into a 1×1 convolution layer with a convolution kernel size being kernel, and global time information of the sample is compressed into a set of channel descriptors z_{c} to mine a correlation between electrode channels. The kernel is calculated by the following adaptive function:

$$kernel = abs ( \frac{{log}_{2} c}{y} + \frac{b}{y} )$$

where abs( ) represents calculation of an absolute value, and y and b are hyperparameters with fixed values. In this embodiment, y=2 and b=1.

Then a sigmoid activation function and a dimension increasing layer are used to return to the same number of channels as the input sample, and the channel descriptor z_{c} is mapped into a set of channel weights as a self-attention weight on electrode channels to generate an activation factor s:

$$s = {F}_{e x} ( {z}_{i} , W ) = σ ( g ( {z}_{i} , W ) )$$

Fₑₓ( ) represents a full connection operation, which is used to learn a correlation between channels, and σ( ) represents a sigmoid activation function. g( ) represents a pooling layer and a one-dimensional adaptive convolution function. WϵR is a parameter of a one-dimensional convolution layer, and zᵢ represents a descriptor corresponding to the i^{th} sample, and a corresponding activation factor s, namely the spatial attention weight, is obtained.

S5.2 Based on a multi-head attention mechanism, input the sample \tilde{Q}ᵢ corrected in step s5.1 into a plurality of identical ECANet models, perform channel separation and attention calculation, capture different feature behaviors in a feature space, adaptively adjust a weight of channel attention, and then fuse output results of all models to obtain a feature vector corresponding to the sample Qᵢ.

### Step 6: Contrastive Learning

For two samples xₖ¹ and xₖ² in a sample pair, after feature extraction in step 5, feature vectors Oₖ¹ and Oₖ² of the two samples in a mapping space are obtained correspondingly.

$${O}_{k}^{1} = {F}_{t} ( {x}_{k}^{1} ) = {x}_{k}^{1} ⊗ f ∈ {R}^{{F}_{t} \times C \times {T}_{k}}$$

$${O}_{k}^{2} = {F}_{t} ( {x}_{k}^{2} ) = {x}_{k}^{2} ⊗ f ∈ {R}^{{F}_{t} \times C \times {T}_{k}}$$

Fₜ represents a feature extraction operation in step 5, and f is a convolution operation function. A fully connected layer is used to perform expansion, activation and dimension reduction on the feature vectors to obtain corresponding estimated values xz₁ and xz₂:

$$x {z}_{1} = {F}_{s} ( {O}_{k}^{1} , W ) = σ ( g ( {O}_{k}^{1} , W ) ) = σ ( {W}_{2}^{′} {δ}^{′} ( {W}_{1}^{′} {O}_{k}^{1} )$$

$$x {z}_{2} = {F}_{s} ( {O}_{k}^{2} , W ) = σ ( g ( {O}_{k}^{2} , W ) ) = σ ( {W}_{2}^{′} {δ}^{′} ( {W}_{1}^{′} {O}_{k}^{2} )$$

δ′ represents an exponential linear unit (ELU) function,

$${W}_{1}^{′} ∈ {ℝ}^{\frac{C}{r} \times C}$$

and

$${W}_{2}^{′} ∈ {ℝ}^{C \times \frac{C}{r}}$$

are parameters of two fully connected layers, and r is a hyperparameter, and represents a scaling factor. Mapping of a sample pair on the same low-latitude projection space is obtained by projection, and a cosine similarity z^{sim} between the two samples is calculated to return a loss function Loss:

$${z}^{s i m} = s i m ( x {z}_{1} , {xz}_{2} ) = \frac{x {z}_{1}^{T} x {z}_{2}}{‖ {xz}_{1} ‖ ‖ {xz}_{1} ‖}$$

$$Loss = - log \frac{( {Σ}_{m m}^{M} exp ( {z}_{m m}^{s i m} ) ) + b b}{{Σ}_{n n}^{N} exp ( {z}_{n n}^{s i m} ) ) + b b}$$

where M is a set of negative sample pairs, N is a set of positive sample pairs, and bb represents a bias value, and is a superparameter.

### Step 7: Online Video Target Detection

Through the operation of the above steps, a classifier can accurately classify three classes: target disappearance, target emergence and no target. In an online detection system, due to the problems of a signal-to-noise ratio and sample imbalance, as well as deliberate camouflage of the target, there is a great possibility of missing detection. This method increases the probability of detecting the target by using a change of ERP P300-D during detection of target disappearance. During online detection, this method detects target emergence and target disappearance, and detection of target emergence or target disappearance is regarded as a hit.

Several common target classification models are used to test performance of detecting the complex target in video streams with or without P300-D assistance, and experimental results are measured by indexes hit and wrong, where hit represents a proportion of the complex targets being correctly detected, and wrong represents a proportion of wrong detection:

$$Hit = ( T P ) / ( T P + F P )$$

$$wrong = ( F N ) / ( T P + T N + F P + F N ) ,$$

where TP represents a number of positive classes predicted as positive classes, FN represents a number of positive classes predicted as negative classes, FP indicates a number of negative classes predicted as positive classes, and TN represents a number of negative classes predicted as negative classes.

The above two evaluation indexes can objectively and comprehensively reflect performance of the detection model, and specific experimental results are shown in Table 1 and Table 2.

TABLE 1

| | Subject1 | | Subject2 | | Subject3 | |
|---|---|---|---|---|---|---|
| Method | hit | wrong | hit | wrong | hit | wrong |
| This method | 0.94 | 0.018 | 0.91 | 0.022 | 0.92 | 0.012 |
| This method without P300-D | 0.72 | 0.022 | 0.66 | 0.023 | 0.71 | 0.019 |
| EEGNet | 0.94 | 0.026 | 0.54 | 0.013 | 0.86 | 0.013 |
| EEGNet without P300-D | 0.64 | 0.045 | 0.24 | 0.011 | 0.56 | 0.014 |
| EENet + ECA | 0.94 | 0.029 | 0.72 | 0.033 | 0.9 | 0.018 |
| EEGNet + ECA without P300-D | 0.71 | 0.028 | 0.38 | 0.036 | 0.78 | 0.019 |
| DRL | 0.88 | 0.33 | 0.78 | 0.005 | 0.9 | 0.037 |
| DRL without P300-D | 0.76 | 0.038 | 0.56 | 0.05 | 0.62 | 0.042 |

TABLE 2

| | Subject4 | | Subject5 | | Subject6 | |
|---|---|---|---|---|---|---|
| Method | hit | wrong | hit | wrong | hit | wrong |
| This method | 0.98 | 0.027 | 0.89 | 0.011 | 0.95 | 0.012 |
| This method without P300-D | 0.94 | 0.027 | 0.66 | 0.012 | 0.81 | 0.011 |
| EEGNet | 0.82 | 0.019 | 0.82 | 0.013 | 0.93 | 0.013 |
| EEGNet without P300-D | 0.74 | 0.021 | 0.66 | 0.011 | 0.88 | 0.014 |
| EEGNet + ECA | 0.96 | 0.029 | 0.84 | 0.033 | 0.84 | 0.015 |
| EEGNet + ECA without P300-D | 0.78 | 0.028 | 0.68 | 0.036 | 0.78 | 0.019 |
| DRL | 0.76 | 0.033 | 0.72 | 0.025 | 0.9 | 0.037 |
| DRL without P300-D | 0.62 | 0.034 | 0.64 | 0.05 | 0.72 | 0.042 |

According to table data, it can be learned that P300-D proposed by this method is used to assist P300 in target detection, which can obtain higher detection accuracy and reduce a false detection rate.

What is claimed is:

1. A method for detecting a complex target in pedestrian re-identification video streams based on an event-related potential (ERP), wherein a plurality of video streams with a same duration are shot at different angles in a same place as experimental paradigms, it is set that no to-be-identified complex target appears in some of the experimental paradigms while in the rest of the experimental paradigms, duration during which a to-be-identified complex target appears is the same, and the method further comprises the following steps:
step 1: collecting electroencephalogram (EEG) data of a subject during watching of the experimental paradigms by using rapid serial visual presentation (RSVP) experimental paradigms in a brain-computer interface (BCI);
step 2: performing filtering and independent component analysis on the EEG data collected in step 1, and then marking ERP features, comprising P300 and P300-D, wherein P300-D refers to a positive peak value lasting for 300 ms after target disappearance;
step 3: respectively intercepting signals in a case of no target, in a case of target emergence and in a case of target disappearance from EEG data processed and marked in step 2, to obtain three types of samples, that is, samples in the case of no target, samples in the case of target emergence and samples in the case of target disappearance; and then combining samples of a same class in pairs to form positive sample pairs, and combining samples of different classes in pairs to form negative sample pairs;
step 4: first inputting the samples into an efficient channel attention network (ECANet), extracting a temporal attention weight and a spatial attention weight, and calibrating the samples; and then inputting calibrated samples into a plurality of ECANets with a same structure, repeating a calibration operation, and finally fusing features output by the plurality of ECANets to obtain feature vectors of the samples;
step 5: calculating a distance between feature vectors of two samples in a sample pair on the same vector space, performing back propagation by using circle loss, and updating model parameters; and
step 6: collecting EEG signals of the subject during observation of the video streams, and inputting the EEG signals into a model trained in step 5 to detect whether the complex target appears and an emergence time and a disappearance time of the complex target.

2. The method for detecting a complex target in pedestrian re-identification video streams based on an ERP according to claim 1, wherein the plurality of video streams are shot at different angles in the same place, and no to-be-identified complex target appears in some of the video streams; in the rest of the video streams, the duration during which the to-be-identified complex target appears is 4 s, while positions, emergence time points and disappearance times of the complex target are different, and clothes worn by the complex target and vehicles used change randomly; the shot video streams are edited so that the duration is 10 s, and the target appears at the 1^{st} s, 2^{nd} s, 3^{rd} s, 4^{th} s or 5^{th} s of the video, and correspondingly disappears at the 5^{th} s, 6^{th} s, 7^{th} s, 8^{th} s or 9^{th} s of the video, to obtain the experimental paradigms.

3. The method for detecting a complex target in pedestrian re-identification video streams based on an ERP according to claim 1, wherein in the experimental paradigms played in step 1, a ratio of a number of experimental paradigms in which the target appears and a number of experimental paradigms in which no target appears is 1:1.

4. The method for detecting a complex target in pedestrian re-identification video streams based on an ERP according to claim 1, wherein the collected EEG data is subjected to Butterworth bandpass filtering, and a bandpass range is 0.1-40 Hz.

5. The method for detecting a complex target in pedestrian re-identification video streams based on an ERP according to claim 1, wherein filtered EEG data is down-sampled to 250 Hz, and then divided into a plurality of segments, and baseline calibration of 0-1,500 ms EEG data after start of playing of an experimental paradigm is performed by using 100 ms EEG data after the start of the playing; after calibration, slices are extracted from EEG data with no target emergence at a certain time interval as the samples in the case of no target; EEG data from 300 ms before target emergence to 1,200 ms after the target emergence is intercepted as EEG data with target emergence as the samples in the case of target emergence; and EEG data from 300 ms before target disappearance to 1,200 ms after target disappearance is intercepted as the samples in the case of target disappearance.

6. The method for detecting a complex target in pedestrian re-identification video streams based on an ERP according to claim 1, wherein the ECANet performs global average pooling operation on input data, aggregates feature maps in space or time dimension to generate channel descriptors, then inputs the channel descriptors into a 1×1 convolution layer with a convolution kernel size being kernel, compresses the convolution layer, returns to the same number of channels as the input data through a sigmoid activation function and a dimension increasing layer, and maps the compressed channel descriptors into a set of weights as the spatial attention weight or the temporal attention weight.

7. The method for detecting a complex target in pedestrian re-identification video streams based on an ERP according to claim 1, wherein feature vectors Oₖ¹ and Oₖ² of two samples xₖ¹ and xₖ² in a sample pair are expanded, activated and subjected to dimension reduction by using two fully connected layers, to obtain corresponding estimated values xz₁ and xz₂, and a cosine similarity z^{sim} between the two estimated values is calculated to return a loss function Loss:
$${z}^{s i m} = s i m ( x {z}_{1} , {xz}_{2} ) = \frac{x {z}_{1}^{T} x {z}_{2}}{‖ {xz}_{1} ‖ ‖ {xz}_{1} ‖} ; and$$
$$Loss = - log \frac{( {Σ}_{m m}^{M} exp ( {z}_{m m}^{s i m} ) ) + b b}{{Σ}_{n n}^{N} exp ( {z}_{n n}^{s i m} ) ) + b b} ,$$
wherein M is a set of negative sample pairs, N is a set of positive sample pairs, and bb represents a bias value, and is a superparameter.

8. A non-transitory computer-readable storage medium, storing a computer program, wherein when the computer program is executed in a computer, the computer performs the method according to claim 1.

9. The method for detecting a complex target in pedestrian re-identification video streams based on an ERP according to claim 4, wherein filtered EEG data is down-sampled to 250 Hz, and then divided into a plurality of segments, and baseline calibration of 0-1,500 ms EEG data after start of playing of an experimental paradigm is performed by using 100 ms EEG data after the start of the playing; after calibration, slices are extracted from EEG data with no target emergence at a certain time interval as the samples in the case of no target; EEG data from 300 ms before target emergence to 1,200 ms after the target emergence is intercepted as EEG data with target emergence as the samples in the case of target emergence; and EEG data from 300 ms before target disappearance to 1,200 ms after target disappearance is intercepted as the samples in the case of target disappearance.

10. A non-transitory computer-readable storage medium, storing a computer program, wherein when the computer program is executed in a computer, the computer performs the method according to claim 2.

11. A non-transitory computer-readable storage medium, storing a computer program, wherein when the computer program is executed in a computer, the computer performs the method according to claim 3.

12. A non-transitory computer-readable storage medium, storing a computer program, wherein when the computer program is executed in a computer, the computer performs the method according to claim 4.

13. A non-transitory computer-readable storage medium, storing a computer program, wherein when the computer program is executed in a computer, the computer performs the method according to claim 6.

14. A non-transitory computer-readable storage medium, storing a computer program, wherein when the computer program is executed in a computer, the computer performs the method according to claim 7.
